(19) United States
(12) Patent Application Publication
(10) Pub. No.: US 2026/0170444 A1
(43) Pub. Date: Jun. 18, 2026

(54) RESOURCE MANAGEMENT SYSTEM

(71) Applicant: Innovative Growth Ventures LLC, San Carlos, CA (US)

(72) Inventors: Brenton Holloway, San Carlos, CA (US); Christopher Klaus, San Carlos, CA (US); Darius Mahamedi, San Carlos, CA (US)

(21) Appl. No.: 19/372,203

(22) Filed: Oct. 28, 2025

Related U.S. Application Data
(60) Provisional application No. 63/713,035, filed on Oct. 28, 2024.

(51) Int. Cl. G06Q 10/0639; G06Q 10/0631

(52) U.S. Cl. CPC G06Q 10/06393; G06Q 10/06315

(57) ABSTRACT

A resource management system ingests records and historical activity data of an enterprise user. The records are analyzed for attributes, and in response to selection of one or more categorical designations, a plurality of lead profiles are determined. Each lead profile is associated with a categorical designation and with an aggregation of attributes for multiple categorical designations of the plurality of categorical designations. A set of performance projections is determined for each lead profile, based at least in part on the aggregation of performance attributes. Recommendations, rankings, and scores for lead profiles can be dynamically synchronized with the enterprise records of the user.

### RELATED APPLICATIONS

This application claims benefit of priority to Provisional Patent Application No. 63/713,035, filed Oct. 24, 2024; the aforementioned priority application being hereby incorporated by reference in its entirety.

### TECHNICAL FIELD

Examples described relate to a resource management system, and method thereof for managing resources.

### BACKGROUND

Many types of enterprises increasingly expend significant resources towards their growth. For example, in the realm of software services (e.g., Software-As-A-Service, or “SAAS”), significant portions of an enterprise resource are designated towards engagement of new customers. In a typical scenario, one or more sales personnel engage personnel of a target entity for purpose of having the entity perform a conversion event (e.g., the purchase of licenses for software licenses for the personnel of the targeted enterprise). The engagement efforts can include initial contact, follow-up communications, demonstration of a product for licensing or purchase, negotiation of terms, execution of a contract, and payment of a purchase order.

To manage their engagement efforts, enterprises often use customer relationship management (“CRM”) software. CRM software service is often implemented as a cloud computing service or platform. The functionality provided by CRM software can enable enterprise personnel to record the occurrence and substance of engagement events, record media reflecting conversations amongst the enterprise and the personnel of the targeted entity, and/or automate notifications and emails for purpose of engagement at various levels (e.g., initial contact, follow-up, etc.). To enable effective use of their personnel, enterprises must also dedicate hardware resources (e.g., workstations, laptops, voice over IP (“VOIP”) phones, etc.) for the engagement personnel, and each personnel is typically allocated a license to access and utilize the enterprises CRM software service. In addition to utilizing CRM services, enterprises also establish one or more internal enterprise networks, for purpose of enabling use of information technology services, data resources, company infrastructure (e.g., intracompany messaging, shared knowledge library, HR resources, etc.). Many enterprises distribute their personnel in geographic areas that are in proximity to their desired customer base. The distribution of personnel at different geographic areas can also require additional resources, such as hardware to expand to expand the enterprises internal network to the geographic locations where the personnel are located.

Efforts that an enterprise makes towards their expansion also generates overhead, and the addition of new personnel can directly attribute to an enterprise's overhead at multiple levels. In addition to compensation, the overhead that is attributable to personnel extends to the acquisition and use of resources, such as hardware and networking resources and CRM licenses.

To better manage their resources, enterprises often utilize software services that monitor the effectiveness of the enterprises engagement efforts. This CRM software, for example, can often track every engagement (e.g., email, conversation, insight, etc.) that enterprise has with an entity that is a customer, or targeted to become a customer. This CRM software can provide data that can be analyzed for various types of performance metrics. The users of the CRM software (i.e., the enterprise personnel) often independently analyze such metrics to determine where their individual efforts are best targeted. However, while conventional approaches provide for performance metrics that can provide insight in how individual personnel can target their efforts (e.g., “intent” score that indicates a propensity of a particular entity to perform a conversion event, “incumbent technology” that can be replaced, etc.), these conventional approaches are not optimized for maximizing transaction values over a given time interval, such as a year. Moreover, conventional approaches fail have shortcomings with respect to providing insight into how technological resources of the enterprise are to be allocated, amongst personnel and/or by geographic region.

Many enterprises utilize a “see how it goes” approach towards expansion, resulting in unproductive use of the technological resources. One typical and unwanted result of this approach is that an enterprise successfully engages a target entity, but the value of the engagement is not optimal, or sometimes insufficient to justify the engagement efforts. By way of examples, the engagement efforts can result in a conversion event where the transaction size is relatively small, and/or the engagement efforts can extend over a relatively long period of time, required personnel expend time that could be better used to engage other potential customers. These types of lackluster conversions can also result in the enterprise being positioned in a situation where product support resources are used to support low value customers.

Still further, enterprises also utilize evaluation technology to evaluate the personnel, particularly with respect to the ability to engage and convert targeted entities. The ability of an enterprise to evaluate their personnel can be crucial—good personnel are often the mechanism of successful growth for an enterprise. Towards this end, conventional approaches rely on managers to allocate leads for human agents. Under conventional approaches, evaluation technology can measure various metrics related to the performance of agents, and even managers, but the primary metric for purpose of evaluation is transaction size. If talented agents are given leads that are likely to result in lackluster conversions, the compensation of the agent is negatively impacted, and the enterprise's evaluation mechanism (if one is used) may fail to recognize the agent as being a potential high performer. The end result is that a potentially high performing agent is lost to the enterprise, sometimes to be replaced by a less capable agent, or even multiple agents, who expend more technological resources for the same result. Likewise, existing approaches generally lack the ability to identify instances when less capable agents are assigned to high-value leads that generate satisfactory transaction values (e.g., agents meet their quota), when more capable agents would have generated higher transaction values.

In context of lead scoring, traditional approaches assign static values based on limited historical data. These methods fail to account for individual salesperson quotas, dynamically changing market conditions, and the need for continuous recalibration as opportunities evolve. The result is misaligned prioritization that does not reflect actual contribution potential toward quota achievement.

### BRIEF DESCRIPTION OF THE DRAWINGS

FIG. 1 illustrates an example system for providing lead profiles, according to one or more embodiments.

FIG. 2 illustrates an example method, according to one or more embodiments.

FIG. 3A through FIG. 3D illustrate example user interfaces for use with one or more examples, according to one or more embodiments.

FIG. 4 is a block diagram that illustrates a computer system upon which embodiments described herein may be implemented.

### DETAILED DESCRIPTION

Embodiments provide for a computer system and method for optimizing resources and/or efforts of an enterprise user with respect to targeting of leads.

In contrast to conventional approaches, embodiments provide for a resource management system that significantly improves the ability of enterprises to target their engagement efforts towards growth, in a manner that promotes efficient use of the enterprise technological resources. Among other benefits, a resource management system as described with various examples can be implemented to maximize the ability of the enterprise to convert high value targets, while minimizing (or even eliminating) instances when engagements are unproductive or lackluster.

In some embodiments, a resource management system as described enables an enterprise to efficiently and effectively distribute their technological resources and network in geographic regions where the greatest impact to positive growth can be had, while also minimizing instances when resources are expended towards geographic growth that is unjustified.

Still further, in some embodiments, an example resource management system is provided to automate allocation of enterprise resources in a manner that optimizes the enterprise for growth. Among other benefits, the resource management system reduces inefficient use of technological resources utilized by the enterprise. Moreover, instances of failed or lackluster expansion, particular geographic expansion, are minimized or even eliminated.

Additionally, in embodiments, an example resource management system can enable and improve upon mechanisms by which agents and resources of an enterprise are evaluated for purpose of performance. Unlike conventional approaches, where agents are given quotas that are tiered to compensation and/or experience, a resource management system as described with various examples can calculate an expected quota for an agent, based on various performance metrics that can be projected for leads assigned to the agent. Through better evaluation, the resource management system enables less churning of resources, elimination of middle-management resources, and better acquisition of human personnel.

According to examples, historical activity data is accessed for a customer enterprise. Based on the historical activity data, category-specific information is determined for a plurality of pre-determined categories. The computer system performs projection analysis using the category-specific information, to predict a result of activities performed for a corresponding set of lead profiles, based on a set of resource parameters, where the set of resource parameters represent a designated or hypothetical allocation of customer resources. Based on the projection analysis, the computer system determines a score (or value) for each of the corresponding set of lead profiles. The computer system generates or otherwise provides a user-interface to display dynamic content that indicates the score or value for each corresponding set of lead profiles.

In examples, a “lead profile” includes a combination of attributes that are shared amongst a grouping of opportunities or targets for an enterprise. In context of examples, an attribute (or characteristic) can include a parameter, or combination of parameters, that are descriptive of the represented industry segment or enterprise. By way of example, a attribute can include a number of employees, a geographic location of the enterprise, a relevant incumbent product being used, one or more revenue metrics (e.g., gross sales, net profits, year-over-year metrics), growth rate, funding stage, a type of resource or technology the enterprise uses, partners or customers of the entity (e.g., ABC computer company supply partners), type of corporation, and/or various other characteristics that are potentially impactful or relevant to conversion actions that a corresponding lead may take. The attributes can reflect values for pre-determined parameters, with a lead profile reflecting a set of entities that share a common set of attributes. In examples, a lead profile can be dynamically defined through, for example, settings (e.g., default settings) that specify a set of parametric values, and/or a dashboard, where a user selects attributes corresponding to parametric values (e.g., industry type, company size, etc.).

In examples, a computer system is implemented to determine scores for lead profiles, where each score indicates a propensity for an enterprise represented by the lead profile to convert, as well as additional parameters such as conversion value, the time to conversion and/or other parametric information. In examples, an enterprise user can include personnel of an enterprise, or individual users that operate within or independently. The score, as calculated by various examples, reflects an optimization metric that incorporates multiple types of parametric input. The score can indicate, for example, an expected value metric (e.g., revenue) by a target unit for a result of activities performed by the enterprise user, where the target unit can correspond to, for example, a quota for a segment or region of the projected enterprises'business. For example, the quota segment can reflect a quota designated to a single engagement resource of the enterprise user, such as an employee or class of employee (e.g., hypothetical employee with experience). When represented by expected revenue metric by target unit (e.g., quota segment), the score can indicate the propensity of an enterprise represented by the lead profile to convert, as well as other parameters that reflect a size or value of the conversion (e.g., by revenue).

By contrast, conventional approaches have ranked or scored leads for enterprise users, based on a determined propensity for the lead to perform a conversion. While propensity scoring is of value, it does not optimize the resources and efforts of the enterprise user.

Further, in at least some embodiments, an example system dynamically evaluates and prioritizes commercial opportunities through real-time data enrichment, artificial intelligence pattern analysis, and mathematically rigorous multi-objective weighting of projected bookings against complex quota attainment requirements.

In additional examples, a system is provided to continuously ingests CRM data of an enterprise user. The CRM data is extracted, analyzed, and autonomously enriched with external datasets (e.g., firmographic attributes, industry classification, growth metrics). In the event enriched data sources conflict as to particular information items, a rules-based approach or logic can be used to prioritize information items based on source, recency, and other selection parameters. From the enriched data set, the system calculates a proprietary lead efficiency score that is uniquely contextualized to specific quota requirements (e.g., for individual users). Unlike conventional static scoring, this system produces a quota-relative efficiency metric that quantifies the projected contribution of each lead toward individual quota completion. Based on the contribution, the enterprise user can select which lead category to dedicate their resources to.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, servers, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

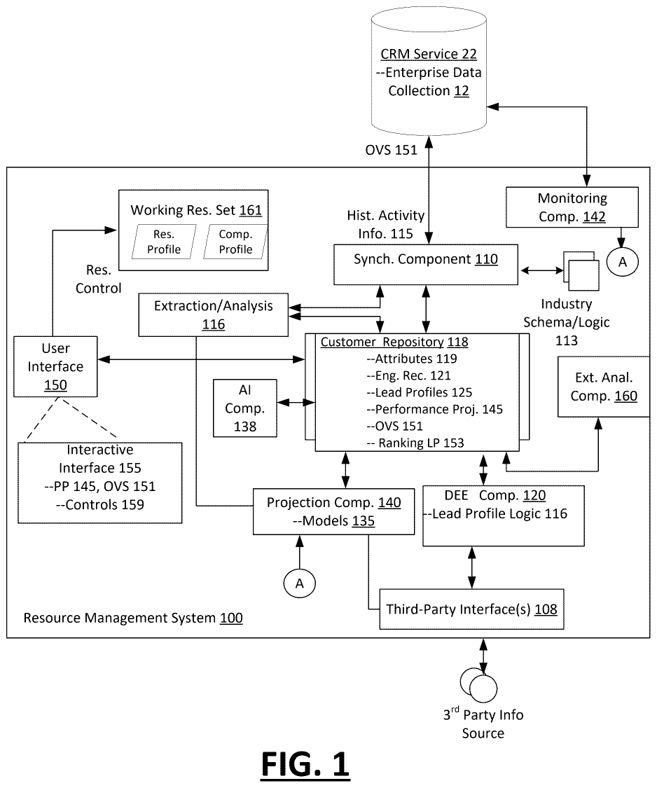

FIG. 1 illustrates an example of a resource management system for optimizing allocation of enterprise resources for targeting lead conversions, according to one or more embodiments. In examples, a resource management system 100 is implemented on a server, or a combination of servers. In variations, the resource management system 100 is implemented by user devices of an enterprise (or enterprise user). Still further, in variations, functionality of the system 100, as described with examples, may be distributed between user devices and/or servers.

In examples, the resource management system 100 operates to connect to an enterprise user/customer account. The system 100 can connect to, for example, a customer resource management service 22 (“CRM” or CRM service 22), accessible to users (e.g., personnel of an enterprise user), to view records and other data items of a data collection 12 for an enterprise user (“enterprise data collection 12”). In conventional approaches, enterprise records can include fields where values identify information specific to an opportunity, such as client or target enterprise name, historical activity performed on the account (e.g., outreaches, engagements, communications), commercial activity metrics of the enterprise conducted through the entity (e.g., sales volume), known information about the enterprise. The system 100 can also connect or otherwise interface with other data sources of an enterprise, to receive historical activity information for an enterprise, where the historical activity information reflects engagements of enterprise personnel with target customers.

With further reference to FIG. 1, resource management system 100 includes a synchronization component 110, a customer data repository 118, a data evaluation and enhancement (“DEE”) component 120, a projection component 140, and a user interface 150. In examples, the synchronization component 110 represents processes that access data stores and resources of an enterprise, to retrieve enterprise data collection 12, from which historical activity information of the enterprise. For example, the synchronization component 110 can access a customer relationship management (CRM) account 22 of the enterprise user, hosted at a third-party site, where an enterprise data collection 12 for an enterprise user is stored. The enterprise data collection 12 can include records for commercial opportunities for the enterprise user, where the commercial opportunities include new markets, markets an enterprise user wants to increase, mature markets, etc.

### Data Ingestion

When enterprise data is initially ingested, the synchronization component 110 can implement one or more extraction and analysis processes, represented by extraction/analysis 116, to identify historical activity information of the enterprise to target opportunities (e.g., entities) for commercial purposes, such as the sale of products and software licenses, through engagement records, log activities, and other data sources. The activities detected by extraction/analysis 116 can range in type, and may be predetermined or predefined. The historical activity information can be reflected in various data sources, including CRM records, emails, notes, and the like.

The synchronization component 110, in combination with the extraction/analysis component 116, can utilize a pre-determined schema 113 to extract information relating to predetermined categorical designations and attributes. Further, the synchronization component 110, in combination with the extraction/analysis component 116, to create engagement records 121 that mirror but enhance the records of the enterprise data set 12. The engagement records 121 can be stored in a customer repository 118, where each engagement record 121 includes or references corresponding historical activity information about the enterprise user's activity with respect to a particular entity. Accordingly, each engagement record 121 can be associated with a particular entity (e.g., enterprise customer) that an enterprise user has engaged in the past.

### Attribute Determination

In examples, the extraction/analysis component 116 scans the enterprise records for historical activity information relating to opportunities (e.g., customers, target customers, etc.). For each record, information corresponding to predetermined attributes of a predefined collection of attributes 119, is extracted and aggregated. The collection of attributes 119 can be predefined to represent categorical designations for opportunities that have previously been the subject of historical activity. The extraction/analysis component 116 can include processes that correlate to, for example, a name or other identifier associated with a particular record (e.g., targeted entity or customer), to industry, subindustry, size, revenue, growth rate, funding stage, a type of resource or technology the enterprise uses, partners or customers of the entity, and various other predetermined characteristics. The extraction/analysis component 116 can also automate retrieval of information for determining attributes specific to historical opportunities and efforts of the enterprise user, using public sources, such as online public directories, government secretary of state sites, industry web pages, news services, etc. In this way, public information about specific attributes is retrieved, normalized, and parameterized in accordance with the attribute collection 119. Over time, some information regarding specific attributes can be maintained locally and used to populate engagement records 121 of other user accounts.

As described in more detail, the extraction/analysis component 116 can include processes to determine quota-related attributes (alternatively referenced as performance attributes) based in part on historical activities reflected by the enterprise data set 12. The collection of attributes can define attributes to reflect a variety of values, including correlate or indicate performance metrics, such as prior attempts to engage/convert an entity, size of engagement, outcome of engagement, renewal opportunities with enterprise, duration in which the enterprise was engaged before conversion or outcome was determined. Prior performance attributes can be normalized, aggregated or weighted based on pre-determined weighting associated with the attribute. If, for example, a targeted enterprise reflects a particular portion of the subindustry, the weight assigned to the performance attributes can be relatively higher than those weights determined from smaller enterprises that may be similar.

More generally, examples enable information retrieved the particular opportunities to be normalized, weighted and combined with information retrieved from other records of the enterprise collection. In this way, at least some performance attributes can be directly determined from the historical activity, and the performance attributes can be used to populate the attribute collection 119 associated with the enterprise user. Performance attributes can also reflect trends, with weights resulting from trends being based on the degree and recency of the trend.

Still further, in additional examples, performance attributes can reflect projections of performance metrics, such as potential sales volume or opportunity value to the enterprise user. Potential sales volume can be determined based on, for example extrapolation prior sales activity by the enterprise user, public information relating to the prior sales activity of a particular entity or segment, public information about projections relating to an industry, etc.

Further, in examples, many attributes of the attribute collection 119 can be determined through inferences, extrapolation, machine learning, similarity comparisons, clustering and the like. For example, the attribute collection 119 can be partially populated with data reflected from potential opportunities that are deemed similar to entities that the enterprise user previously engaged with.

The historical activity information 115 associated with the records of the enterprise can also be weighted for recency, trends, and enterprise or user-specific considerations. For example, weighting used to determine specific performance attributes for an opportunity can be adjusted for geography, meaning a user in a first geographic may have a performance attribute that is different than a performance attribute of a user in a different geographic region. Thus, specific attributes of the attribute collection 119 can be associated with weights, where the weights are dynamically determined (e.g., in real-time) based on, for example, aspects of the user, an input query, contextual information, or real-world events.

In examples, the system 100 can associate the collection of attributes 119 with the enterprise user, and the collection of attributes 119 can subsequently be used to dynamically determine lead profiles 125. The collection of attributes can be continuously updated, through activity of the enterprise user, as well as published information relating to entities/opportunities that share the attribute, and real-world events. In this way, the system can continuously update the attribute collection 119 associated with each enterprise user, and the attribute collection can be used to update the records of the enterprise data set 12 as stored with, for example, the CRM 22.

In examples, the weighting and performance-related attributes of the collection can be adjusted based on real-world events, as well as contextual information (such as for cycle timing, quota periods, and seasonality). The calculations can further be performed using artificial intelligence, machine-learned models and processes.

Further, in examples, performance-related attributes can be projected based on predictive determinations, made through historical data and predictive models, as well as events and date determined through monitoring of external data sources (e.g., real-world events). In this respect, events can change the attributes associated with the opportunities of the enterprise user, and the processes of system 100 can update the values dynamically and in real-time.

### Engagement Records

The schema 113 can be configured based on information that is specific to the enterprise user profile, such as the user's industry, product, geography, and/or requirements. In additional examples, the schema 113 can be configured for (i) an industry type of the user, (ii) a product or service type (e.g., software license, services, products, etc.) that is the subject of the user's engagement efforts with customer enterprises, (iii) a geographic location or area of the user, or of the user's interest, and/or (iv) one or more objectives of the user (e.g., revenue growth, employee count, etc.).

The synchronization component 110, in combination with the extraction/analysis component 116, implement processes that utilize the schema 113 to map information contained in the enterprise data collection 12to predefined fields of engagement records 121 that are associated with the particular entity. The synchronization component 110 can further include processes for processing and normalizing information contained with the enterprise data set 12. In this way, the customer repository 118 can maintain a collection of engagement records 121 for the enterprise user, with historical activity information of the customer being referenced in the engagement records 121. In some examples, the engagement records 121 can mirror (or substantially mirror) the records of the enterprise data set 12, with the engagement records 121 including enhancements (e.g., scoring) that is synced back to the enterprise records, as stored with the CRM 22. Additionally, as described in further examples, the engagement records 121 can be enhanced or augmented with scoring and quota-related value metrics.

In examples, the collection of engagement records 121 can include fields that are based on an attribute schema 119. As described, the engagement records 121 are processed to determine parametric information that can be used to enhance or augment the enterprise records stored with the third-party CRM service 22. The enhancement or augmentation can integrate or merge parametric values and scores with the enterprise records stored with the third-party CRM, to value or otherwise prioritize individual enterprise records (e.g., representing an individual entity, such as a target client), particularly for a scenario or specific context. Accordingly, in examples, the customer repository 118 can maintain a collection of engagement records 121, where each engagement record identifies an associated enterprise, as well as information items (e.g., data fields) that include information about the entity, information about the activities the enterprise user performed with regards to the entity, and information about an outcome of the enterprise's user efforts to engage the entity.

In an example, each engagement record 121 includes attributes (or fields) as specified by an attribute schema 119. The fields for an engagement record 121 can include, for example, (i) an associated entity identifier (e.g., name of enterprise), (ii) one or more fields that reflect an industry (and optionally a sub-industry) of the entity (or relevant industry for purpose of the enterprise user's activity), (iii) a set of fields reflecting information about the entity, such as a number of employees, a geographic location of the enterprise, one or more revenue metrics (e.g., gross sales, net profits, year-over-year metrics), growth rate, funding stage, a relevant incumbent product being used by the entity, a renewal rate (or the likelihood that an enterprise of the lead profile will renew a product license), an intent score indicating a propensity of the entity to purchase (or change the incumbent product), and/or various other characteristics that are potentially impactful or relevant to a conversion event for that entity. Further, each engagement record 121 can include fields that reflect metrics of outcome of the user's prior engagement efforts with the entity, such as whether the engagement was successful (i.e., the entity converted, such as purchasing products from the user), the size (e.g., in revenue, units sold, etc.) of the conversion transaction (“conversion transaction size”), whether the entity renewed or had an additional engagement (e.g., entity renews their licenses from prior conversion event), and a conversion duration cycle, reflecting the time interval from when the associated entity was first contacted to the time when the entity performed the conversion.

As an addition or alternative, the historical data store interface 110 can include processes that access and process local data sources (e.g., local databases) to obtain historical activity information 115. In such examples, the historical activity information 115 can include records, documents, and other information items that reflect efforts of the enterprise user to target other enterprises for a commercial purpose (e.g., the sale or licensing of a product). Accordingly, the information interface 110 can include processes that retrieve the historical activity information 115 from disparate sources, including unstructured sources. For example, the historical activity information 115 can be retrieved from a variety of data stores, such as mailboxes, document repositories, financial records, calendars and notes. In such examples, the historical data store interface 110 can include processes to parse, scan, perform optical character recognition (OCR), and other analyses processes, to extract information for populating engagement records. The extracted information identifies enterprises that were a target of engagement, a purpose of the engagement, a time when the engagement was initiated and ended, information indicating whether the engagement was successful, a size of conversion for successful engagements, and the like. For example, the synchronization component 110 can include processes that identify an attempt at engagement (e.g., an outgoing email), a target of the engagement, a begin and end date of the engagement (e.g., based on emails and invoices), and information that indicates an outcome of the efforts (e.g., invoice to the engaged entity, indicating a size of the conversion). The synchronization component 110 can use the extracted information to populate engagement records of the customer repository 118. In this way, the synchronization component 110 can aggregate and structure the historical activity information 115 into engagement records 121 of the customer data repository 118.

### Augment/Enhance Historical Information

The DEE component 120 can include processes that scan the customer repository 118 and augment or enhance the engagement records 121. In examples, the DEE component 120 programmatically analyzes the engagement records 121 to identify missing information items in individual records. The DEE 1 component 20 can also identify instances when expected or required data sets are omitted, or inadequately provided. The DEE component 120 can include programmatic processes that access third-party information sources, via a third-party interface 108 and/or connector, to retrieve omitted information. By way of example, the DEE component 120 can initiate automated processes to access third-party information sources (e.g., corporate directories, secretary of state data stores, third-party marketing sites, entity websites, etc.), and to retrieve and populate engagement records 121 that may have deficiencies or omissions with regards to information contained. The DEE component 120 can, for example, associate specific processes and connectors for particular fields or types of information items, and in response to detecting omitted or deficient information, automatically trigger a process to retrieve the omitted information from an external source via the third-party interface 108.

### Lead Profiles

In examples, the DEE component 120 implements lead profile logic 116 to determine lead profiles 125, based on the collection of engagement records 121. As described with examples, each lead profile 125 by a set of multiple attributes (or categorical designations), where each attribute reflects a value of a predetermined parameter. Lead profiles 125 can be dynamically determined, based on, for example, user input specifying a desired set of attributes, in a particular order. For example, lead profiles 125 can be dynamically determined based on categorical designations that specify, industry, industry sub-category, size (e.g., as measured by revenue) and/or geographic region. Alternatively, lead profiles can be determined based on categorical designations that specify entity size, entity revenue, existing technology, and partner or supplier.

While in some cases a lead profile 125 can represent a specific enterprise, in examples, each lead profile 125 can be a representation of multiple enterprises that are deemed similar to a particular lead, based on a predetermined set of categorical designations that collectively define lead profiles. For example, a lead profile 125 can represent entities of a particular size, industry segment or other shared characteristic. In this way, each lead profile 125 can reflect a hypothetical enterprise of a pre-defined category (or customized categorical set), and each lead profile can be associated with attributes or characteristics that are determined at least in part from the historical activity information of the enterprise data collection. The attributes or characteristics that are determined from historical activity information can reflect prior engagements and/or attempts at engagement by enterprise personnel with specific customers (e.g., other enterprises) that are associated with the lead profile. Lead profiles 125 can also be determined to identify a set of lead characteristics that are descriptive of a representative industry sub-category, or alternatively of a specific lead (i.e., a potential enterprise customer). By way of example, lead profiles 125 can be defined based on corresponding lead characteristics that can include an indicator for each of a number of employees, a geographic location of the enterprise, one or more revenue metrics (e.g., gross sales, net profits, year-over-year metrics), growth rate, funding stage, a relevant incumbent product being used, a renewal rate (or the likelihood that an enterprise of the lead profile will renew a product license), an intent score indicating a propensity of a representative enterprise to purchase a relevant product, and/or various other characteristics that are potentially impactful or relevant to conversion actions that a corresponding lead may take.

In examples, the lead profile logic 116 can be implemented to scan the collection of engagement records 121 for the enterprise user's account. Each engagement record 121 can be associated with characteristics, reflecting attributes or parametric values that can be used to dynamically define lead profiles 125. For each determined lead profile 125, one or more lead characteristics can reflect an aggregation of corresponding information items (e.g., as represented by a field of an associated engagement record) for each engagement record that is associated with the lead characteristic. For some lead characteristics, the value of the lead characteristic can be based on an average or weighted average. For example, lead characteristics representing employee count, revenue metrics, and growth rate can be determined from an averaging, or weighted averaging of the corresponding field values. Other lead characteristics, such as incumbent or intent score, can be determined by the most likely value, based on a statistical analysis of corresponding field values in the constituent engagement records 121.

### Performance Projections

The projection component 140 can dynamically determine performance metrics for lead profiles, based in part on the determined performance attributes of the collection of attributes. As described with examples, lead profiles 125 can be determined based on a designated or selected set of attributes. For a determined set of lead profiles, each lead profile 125 can be associated with a set of projected performance metrics (or “performance projections 145”), where such performance metrics relate to a likelihood or probability of a conversion event occurring with a prospective entity of the lead profile. Examples of performance projections 145 include (i) a projected conversion score, reflecting a probability that an enterprise of the lead profile will perform a conversion event, given other information of the lead profile; (ii) a projected conversion duration cycle reflecting a time interval, measured in, for example, a number of days or a percentage of a year, expected for an enterprise represented by the lead profile to be actively engaged until that enterprise performs the conversion event; and (iii) a projected conversion size, reflecting, for example, a size of a transaction for the conversion event (e.g., measured as gross receipt). As an addition or variation, a set of projected performance metrics can include a renewal metric, reflecting a likelihood that a representative entity of the lead profile will perform a subsequent conversion event after an initial conversion event (e.g., purchase a renewal after an initial license, etc.). As described with examples, the projection parameters 145 can be predictively determined, using predictive or stochastic models, from an aggregation of attribute values related to specific categorical designations.

As another addition or variation, another performance projection can be based on an upsell/down-sell or expansion metric, reflecting an entity of the lead profile 125 having previously increased or decreased their prior product purchase (e.g., “Net Retention Rate” or “NRR”). Based on historical information, such performance projection can reflect, for example, a likelihood of an entity of a lead profile increasing (e.g., upsell), decreasing (e.g., down-sell) or remaining even (e.g., flat) their commitment to additional products, upgrades, services and the like. More generally, a performance metric can reflect any characteristic that is based on or related to a conversion event.

In examples, the projection component 140 determines a projected conversion score based on outcomes contained in the historical activity information of the enterprise data set 12. The conversion score can reflect a projected “win rate” of the end user with respect to entities that are associated with the lead profile. For example, the projection component 140 can determine the projection score based on a comparison of (i) the number of times the enterprise user successfully engaged entities that are associated with that lead profile, and (ii) the total number of entities engaged by the enterprise user for entities of the same lead profile, for both successful and unsuccessful outcomes. By way of example, the win rate metric can include a ratio of the number of entities of the lead profile that had conversion events versus a total number of entities of the same lead profile that were engaged. The projection component 140 can also perform weighting when determining the projected conversion score. For example, the projection component 140 can weight an outcome with a particular entity based on the level of engagement or effort the enterprise user made in engaging the enterprise user (e.g., the number of personnel who engaged the entity, whether certain metrics occurred during the engagement, the duration of the engagement, etc.). Past outcomes can also be weighted based on a predicted conversion event value versus the actual value, as well as other factors.

Likewise, the characteristics of a conversion duration cycle can be based on an average, or weighted average, of the time interval that each conversion event took. Additionally, the characteristic of the conversion transaction size can be based on an average, or weighted average, of the corresponding values that is specific to the lead profile 125. As an addition or variation, the performance projections can be associated with a set of weights that factor, for example, market trends, external factors (e.g., Federal interest rate) and/or ongoing engagement efforts of the enterprise. Trend analysis can also be performed using the customer CRM 22 and/or customer data repository 118, and identified trends can be used for a variety of purposes, including determination of performance projections, metrics, overall value score and/or confidence values.

As an addition or variation, the performance projection 120 can scan the engagement records 121 and/or historical activity information to determine the number of events in which the target entity is engaged, the expenditures incurred with regards to the engagement (e.g., direct monetary cost associated with engaging entity), the amount of time required by an enterprise user's personnel for the engagement (e.g., travel time, meeting time), the amount of interaction incurred by the entity (e.g., number of contacts by personnel of enterprise user, such as number of phone calls or in-person meetings, type of contact, etc.), and/or other factors (collectively referred to as “effort metric”). In some examples, the projection component 140 can calculate an effort metric, as well as an expenditure metric, for engagement records 121 relating to corresponding entities. Further, the projection component 140 can calculate effort and/or expenditure metrics for corresponding lead profiles, based on the recorded historical activity of the enterprise user. In some variation, the effort and/or expenditure metrics can be calculated by external or third-party processes, and integrated into the engagement records 121. The effort and expenditure metrics can be used to determine, for example, an overall value score for a lead profile, as described with examples.

The projection component 140 can utilize one or multiple processes of different types in determining performance projections 145, based on, for example, the number and contents of engagement records 121. As described with some examples, the projection component 140 can utilize statistical modeling and processes to determine the performance projections 145, based on engagement records 121 reflecting the historical activity of the enterprise user. However, examples recognize the accuracy of statistical models and processes can depend on the quantity, quality and recency (collectively the sufficiency) of the historical data from which the statistical models and processes are made. Various factors can influence the sufficiency of the historical data collection (as provided by the engagement records). For example, if the enterprise user is relatively new, or just branching out into a market, then the number of engagement records 121 reflecting prior historical activity for a given market segment may be limited, requiring processes to enhance or augment the engagement records 121 with information from third-party sources 109.

Still further, in some cases, system 100 can be used to generate simulations, where the user can investigate potential new markets for a given enterprise. In such case, the user can simulate historical activity and performance attributes, to determine likely scenarios of the enterprise user engaging in a particular market. Likewise, the simulation input can be used to enable the enterprise user to alter performance attributes in order to simulate best and worst case scenarios.

In some examples, the projection component 140 makes a determination as to whether the amount of historical data that is relevant for a particular lead profile meets a first threshold, where the relevant historical data is reflected by engagement records 121 that relate to an entity that is associated with, or meets the criteria for, a lead profile. For example, the threshold can be designated to be X (e.g., 10, 20, etc.) instances where an enterprise represented by a particular lead profile was engaged or otherwise targeted for a conversion event. In an implementation of FIG. 1, the threshold can be based on the engagement records 121 associated with entities of the particular lead profile. If the first threshold is met for a particular metric of the lead profile, the projection component 140 calculates the performance projection 145 based on an averaging process.

On the other hand, if the first threshold is not met, the projection component 140 can utilize an alternative process to determine one or more performance projections 145 for lead profiles 125. As an example of an alternative process, when a given lead profile 125 the projection component 140 can identify one more similar lead profiles 125, based on, for example, select characteristics of the lead profiles. The projection component 140 can then calculate or determine the performance metrics for the lead profile 125 using the respective outcome of engagement records 121 associated with the similar lead profile(s) 125. Still further, in some examples, one or more statistical models 135 may be used to determine the performance metrics for lead profiles 125 with insufficient data points (e.g., engagement records less than the first threshold), using performance metrics of other lead profiles 125 that are deemed similar. The determination of similarity amongst engagement records 121 and lead profiles 125 can be determined through, for example, Euclidean distance or Gaussian distribution, to facilitate the determination of performance metrics for a given lead characteristic.

As described with some examples, performance projections 145 can be based at least in part on historical information of the enterprise user. In variations, the projection component 140 can utilize third-party information sources to determine one or more performance projections 145 of the lead profiles 125. The types of predictive modeling can also vary based on implementation, as well as the quantity and quality of the data set. For example, in some variations, predictive models 135 used for determining one or more metrics can include neural networks or simulation models.

In some examples, the resource management system 100 can monitor the engagement activities of the enterprise user with respect to enterprises that are associated with engagement records 121 and/or lead profiles 125. The monitoring component 142 can identify parametric information that can be compared against performance projections 145, as determined by one or more models used by the projection component 140. The monitoring component 142 can identify instances when an enterprise associated with a given lead profile performed the conversion event, the time interval for the conversion event to take place, a size of the transaction underlying the conversion event, and/or other factors which are related to individual performance projections 145. Based on input of the monitoring component 142, the projection component 140 can update or otherwise tune individual models to improve their respective accuracy.

In some examples, the processes which the projection component 140 utilizes to determine performance projections 145 can associate different confidence scores with each determination of a performance metric. For example, a statistical process that generates performance projections 145, based on the data set is deemed sufficient for a corresponding lead profile 125, can have a relatively high confidence score. Conversely, a simulation model that utilizes data sets associated with multiple lead profiles that are deemed similar (e.g., such as in the case when there is insufficient historical activity data) can have a relatively low confidence score. Moreover, the determinations made through statistical processes or modeling can also be associated with confidence intervals. For example, each performance projection can be associated with a statistical range, reflecting probabilities for different outcome (e.g., a particular transaction size that is two standard deviations greater than the average). As described in greater detail, in some examples, user interface 150 can include a slider or other continuous input mechanism that allows for the user to specify an acceptable confidence score along a continuum. If the user chooses to lower their confidence score, the performance projections may vary in range, to account for lower probability outcomes, or outcome generated by alternative processes.

### Scoring

According to examples, the projection component 140 determines an overall value score 151 for specific opportunities (e.g., customers or potential customers of the enterprise user) and/or lead profiles 125, where the overall value score is based at least in part on one or more performance projections 145 calculated for the respective lead profile. In examples, the overall value score 151 can be a multidimensional value, representing one or more calculations based on performance projections 145, historical performance attributes, confidence scores and/or other metrics.

In an example, the overall value score 151 is based on a product of a projected transaction size for a conversion event with a particular entity, or representative entity of the lead profile 125, and a probability that engagement with the representative entity of the lead profile 125 will result in the conversion event (i.e., the win rate). Still further, in examples, the overall value score can also take into account the projected conversion duration cycle for the lead profile. In a variation, the overall value score 151 can reflect the projected conversion duration cycle as a cost, meaning the shorter the projected conversion duration cycle, the greater the overall value score 151. In some examples, the projected conversion duration cycle can be based on a comparison with a predetermined unit of time (e.g., average cycle time, over the course of a financial calendar quarter, over course of a year, etc.). The overall value score can 151 be reflected as a ratio or percentage that is relative to a baseline quota. In such implementation, an overall value score 151 can be calculated to take into account the projected cycle time, where a shorter conversion duration cycle results in a higher overall value score, and a relatively longer conversion duration cycle results in a higher overall value score.

In this way, the overall value score 151 can provide a personalized or tier-specific metric to value the efforts of an agent. Still further, in other examples, the overall value score 151 can enable the resource management system 100 to be utilized as a tool, by individual sales agents, who can specify their own quota, or even desired quota, to readily identify which leads offer the best opportunity for that agent.

In some examples, the overall value score 151 can be calculated for a number of lead profiles 125 (e.g., hundreds or even thousands) repeatedly, or continuously. The processes represented by the projection component 140 can include, for example, dedicated processes or a separate engine, to calculate and recalculate the overall value score 151 for a collection of lead profiles. The updates to the overall value score 151, and/or their respective confidence scores, can be done continuously, such that the customer data repository 118 includes updated calculations for the overall value score 151 of each lead profile 125, as well as to their respective performance projections 145.

As described with examples, the overall value score 151 can also incorporate or otherwise factor effort and expenditure metrics. For example, the overall value score 151 for a particular lead profile can be negatively impacted if entities of the particular lead profile are deemed (based on historical activity) to require a relatively large amount of expenditures (e.g., travel cost) and/or effort (e.g., man hours by enterprise user personnel).

Additionally, the overall value score 151 can integrate factors such as the NRR, as calculated for the lead profile. The NRR can reflect, in monetary value, percentage, or otherwise, the likely retention value for a particular entity of a lead profile, given historical information and current information regarding the enterprise's engagement efforts.

In examples, the overall value score 151 can be based in part on a target unit (e.g., quota). More generally, the overall value score 151 can be a weighted blend calculation, such as determined by a weighted blend for a quota, where the weighted blend normalizes the quota or value across multiple segments, regions, or categories, where each would otherwise have their own unit, value or quota, when calculating a variable or set of variables. For example, when a lead profile's performance is estimated in a particular category (e.g., finance entities), the historical data points that reflect activities with regards to various segments of entities with varying numbers of employee sizes, with each segment having its own quota. In such case, the quota that is used to assess performance would be a weighted value that would be calculated based on the number of entities (or engagement records 121) and their respective quota (as individually determined). Still further, in additional examples, lead profiles 125 can be evaluated for quota-related attributes using a multi-attribute function. The multi-attribute function can calculate a normalized, quota-weighted score that represents the potential financial contribution to a given quota (e.g., for a quarter, for an individual or team, etc.). The quota-weighted score can be calculated using performance attributes and parameters for a given lead profile 125.

### User Interface

The user interface 150 can generate or otherwise provide an interactive interface 155 for one more user devices (e.g., enterprise workstation, desktop computer, laptop computer, mobile device, etc.). By way of example, the interactive interface 155 can be implemented as a webpage, or as a mobile application interface.

In examples, the user interface 150 can display an overall value score 151, in context of individual engagement records 121, where the overall value score projects a future value of a lead profile associated with an entity of the engagement record 121. The overall value score 151, can also be implemented as a relative metric that is based on a personnel cost, such as a quota (e.g., 120% representing the value-to-cost of the lead). As described with some examples, the overall value score 151 and performance projections can be calculated for the entity associated with the engagement record 121 and/or lead profile 125. When individual leads are viewed (e.g., such as by a user opening an engagement record), the overall value score 151 and/or performance projections of the associated lead profile can be viewed with the contents of the engagement record.

In an example, the user interface 150 can provide the interactive interface(s) 155 with a set of controls 159 for the user to manipulate, in real-time, determinations made by the projection component 140. The controls 159 can include knobs, sliders or other virtual input mechanisms that enable the user to specify parametric input such as representing a confidence score for the output of the lead profile 125, to enable the user to view a range of possibilities for each lead profile, including best case scenario (e.g., highest possible overall), and the probability of that result being achieved. Thus, through manipulation along a continuous input domain, the controls 159 can enable the user to view performance projections and/or overall values scores that are best-case scenario, rather than the most likely scenario, or alternatively, optimistic scenarios versus more pessimistic outcomes. The user can also interact with the controls 159 to specify, for example, input for determining the lead profiles 125. In some examples, the continuous input mechanism 159 can enable the user to implement simulations where the confidence score can be varied based on input from the continuous input mechanism. The continuous input mechanism 159 can be used to vary the statistical significance for difference scenarios, or alternatively, the value of the confidence score, along a range of values, based on a threshold selection of the user. For example, a given user may use the control input mechanism 159 to run a simulation for given lead profiles, enabling the user to weigh tradeoff between high-risk, high-reward scenarios, versus low-risk, low-reward scenarios.

Further, with alternative scenarios, the controls 159 can enable the user to view assumptions or precedent conditions for such outcomes to take place, such as a win rate amongst entities that are associated with a lead profile, a target transaction size (or average transaction size amongst lead profiles) for each projected conversion event, and a target conversion duration cycle for each projected conversion event. In some examples, the controls 159 enable the user to adjust the performance projections, such as by increasing or decreasing each of the win rate, target transaction size, and target conversion duration cycle. The controls 159 can implement, as a real-time response to such input adjustments reflected by the user's manipulation of a control features, simulation output that utilizes one or more assumed or hypothetical performance projections (as altered by the user), in order to view the overall value score 151 for the lead profile. Thus, for example, the user can run scenarios where the user manipulates the controls 159 to vary a performance projection (e.g., win-rate) over what is projected based on historical information. In response to such input from the user, the user interface 150 (through communication with other components are logic such as provided with projection component 140) can calculate the impact of the change to the overall value score 151 for a corresponding lead, lead profile or industry segment.

Still further, in examples, the controls 159 enable the user to enter a desired or target overall value score for a determined lead profile. The user interface 150 can communicate the desired or target overall value score to the projection component 140, which in turn calculates performance projections for enabling the user to achieve the desired overall value score for a given lead or lead profile. The user interface 150 can then output, in real-time and in response to the control input of the user, performance metrics that would need to be met for the particular user to achieve an outcome reflected by the overall value score 151. For example, to increase the overall value score 151 by 10% (as specified by user input) for an industry segment reflected by one or more lead profiles, the interactive interface 155 may display an output that indicates an adjustment or target value to individual performance projections, such as the projected win rate, the projected transaction size and/or the projected transaction duration cycle. As an addition or alternative, the user interface 150 can utilize the confidence scores to determine a probability of a goal being met, such as where the goal corresponds to, for example, a quota, profitability, and/or renewal rate. The user interactive feature 155 can display one or more such probabilities (or risk scores), based on a goal setting input (e.g., input specifying a goal for quota, profitability, and/or renewal rate).

As with other examples, the controls 159 can input can enable the user to provide continuous input along a defined domain (e.g., through manipulation of the slider or turn dial, etc.), with the generate output (e.g., overall value score) being displayed with the interactive interface 155 in real-time. The use of continuous input mechanisms, such as sliders or dials, can have particular advantages in that they readily enable a user to internally define and arrive at a desired optimal outcome. In other words, such input mechanisms may recognize that the user may not necessarily know the specific combinations of performance metrics that will ultimately yield a desired outcome that is optimal to the user. However, through use of such input mechanisms, the user may quickly arrive at a target, defined by hypothetical metrics that serve as goals rather than projections. Alternative interactive paradigms, on the other hand, can be overly manual, labor-intensive, slow and lead to more inaccurate results.

Still further, in other examples, the interactive interface 155 enables an enterprise user to evaluate individual agents based on an expected performance, rather than a predetermined quota. This enables the enterprise user to better evaluate the performance of agents and use resources efficiently.

### Ranking Lead Profiles

In addition to scoring, the system 100 can enhance the engagement records 121 by identifying the best/worst lead profiles 125. As described with examples, lead profiles 125 can be dynamically determined from a subset combination of attributes that tally in the tens or hundreds by count. Evaluating each possible lead profile 125 can mean millions, or magnitudes of order more combinations. To identify the best lead profile, based on a combination of select attributes, the system 100 can utilize an artificial intelligence component 138, such as an interface to a third-party service (e.g., CORTEX AI), to evaluate the combinations and to rank the lead profiles 125 with the best and word projection parameters and/or OVS 151. The rankings or best/worst selection can also be propagated to the records of the enterprise user data set 12, stored with the CRM 22. By ranking lead profiles, enterprise users can rapidly identify engagement targets that meet the profile, to maximize the return on their engagement efforts. The rankings of lead profiles 125 can be surfaced in multiple ways, such as ranked list, recommendation, or strategic plan. The recommendations can also take into account quota-specific constraints, such as timing of conversion date (based on projections, modeling, etc.), territory, industry segment, product, etc.

In some examples, the AI component 138 can also be used to enrich data sources used by the engagement records 121. For example, when data set for an engagement record, attribute or profile lead is insufficient, the AI component 138 can retrieve, process, format and write the processed data set into the engagement record 121.

In variations, the ranking or recommendations can be performed through alternative programmatic methods, including pattern recognition, heuristics or rule-based determinations.

### Records Merge and Synchronization

The synchronization component 110 can merge the engagement records 121 with corresponding records of the enterprise collection 12, such that the records of the enterprise data collection 12 are updated to reflect the OVS 151, or otherwise reflect scoring and quota-related value metrics. In this way, the records of the enterprise collection 12 are enhanced or augmented, while being made available to the personnel of the enterprise user. The synchronization component 110 can update the records of the enterprise data collection 12 in real-time, and/or responsive to events that affect, for example, performance attributes and projection parameters 145. In this way, the system 100 can read and write to the CRM 22, to retrieve and update enhancements of the enterprise user records in near real-time.

Moreover, the records can be enhanced/augmented to reflect specific context or scenarios. For example, multiple scores or quota-related value metrics can be associated with an entity record based on the geographic location of the enterprise personnel. Thus, the record of the enterprise data collection can reflect multiple quota-related value metrics, for enterprise personnel in different geographic regions.

### Real-World Events

In examples, one or more of the projection parameters 145 and/or OVS 151 can be modified or otherwise determined in real-time, responsive to real-world events. For example, the projection component 140 can include external-facing processes that monitor information sources for publication of events that can drive markets or companies with regards to expenditures, growth etc. The projection component 140 can use artificial intelligence and/or machine-learning models to weight projections and performance attributes in response to specific types of events (e.g., inflation report, interest rate, industry leader earnings, etc.). Upon detection of such events, the projection parameters 145 and/or OVS 151 cam be updated and synchronized with the CRM 22 to make the enhanced values of the enterprise data set available to personnel as needed.

Further, in examples, the overall value score 151, as well as performance projections calculated for lead profiles, can be repeatedly or continuously updated through monitoring or tracking of events performed through the enterprise, or through updates obtained from third-party information sources. For example, real-world events (e.g., surprising earning announcement by an entity of a given lead profile) can impact the performance metrics and/or overall value score of an entity. The resource management system 100 can include processes (e.g., such as represented by the extraction/analysis component 116) that monitor information sites for predetermined events (e.g., stock announcements, global economic announcements by the government, etc.). In some examples, the resource management system 100 can utilize an external event analysis component 160 that monitors information resources for real-world events. The event analysis component 160 can also host, or accesses trained models (via model interface) to project metrics such as expected industry spending in response to real-world events. Based on such events, the event interface updates to performance metrics and overall value scores 151 that are associated with lead profiles. When engagement records reviewed, the overall value score and/or other performance metrics can be dynamically updated and displayed.

As an addition or variation, the resource management system 100 includes processes, represented by the external analysis component 160, to monitor external data sources, in order to detect real-world events that relate to the target customer entities, market and opportunities of the enterprise and its personnel. Such events can include, for example, financial markets, publication of government statistics (e.g., unemployment rate, inflation rate, debt rating), earnings reports for companies in industry, analyst reports, product announcements, weather reports, news reports and events, and the like. In examples, the external analysis component 160 detects relevant events to attributes associated with lead profiles, and based on historical analysis and/or artificial analysis, estimates impact to a particular set of attributes, or combination of attributes (e.g., scenario). The impact can be measured to attributes that reflect, for example, an industry, sub-industry, geographic location, debt level (e.g., debt-to-income), company size, etc. In examples, the external analysis component 160 utilizes one or more machine-learning models to (i) identify events of potential impact, (ii) determine attributes that are most likely impacted by such events, and (iii) adjust attribute values, globally or in particular context or scenarios. The model(s) deployed with the external analysis component 160 can be trained on historical data. The external analysis component 160 can adjust lead attributes, such that engagement records 121 are updated to reflect the changes. The monitoring component 142 can monitor outcomes where attributes are adjusted, to enable the models 135 used by the external analysis component 160 to be updated or tuned in response to detected events.

In examples, the external analysis component 160 programmatically or automatically updates the customer data repository 118, such that the engagement records 121 reflect changes as they occur. Further, the projection component 140 can responsively update the lead profiles 125, including the performance metrics 145 and/or overall value score 151 associated with each lead profile 125. In this way, the attributes associated with engagement records 121 reflect recent events, as predicted by the machine-learning models and processes of the external analysis component 160. Further, the synchronization component 110 can synchronize the engagement records 121 with the records of the enterprise data set 12, such that the enterprise data set 12 as stored with the CRM service 22 reflect the changes made to the attributes by the external analysis component 160, and the changes can be reflected in real-time. Further, the user interface 150 can dynamically update a user interactive interface 155 to reflect an update to performance projections 145 and/or overall value score 151 for a particular lead profile 125, responsive (e.g., in real-time or near real-time) to, for example, (i) an occurrence of a world event (e.g., surprising earning announcement by leader for market segment, surprising interest rate announcement by Federal Reserve, etc.), (ii) responsive to a personnel reflecting a new outcome for a targeted enterprise of that lead profile, and/or (iii) trend analysis, performed with respect to outcomes or activities performed by the enterprise user, and/or external trends reflecting market trends.

For example, a lead profile 125 coinciding with one entity, or multiple entities, can be heavily impacted with a company-specific event that has significant impact on the projection parameters 145. For example, significant events, such as acquisition of the entity, stock earning surprise, a government investigation, or executive changes can significantly impact the OVS 151. The system 100 includes processes to monitor for such events, and to modify the OVS 151 for a lead profile of the impacted company or industry, such that the OVS 151 is dynamically determined and synchronized to the enterprise data set 12 stored with the CRM 22. The system 100 can implement real-time monitoring, the OVS 151 can quantify the degree of consequence resulting from the event, allowing the enterprise to reconsider or increase efforts with the affected lead profile 125.

In examples, the user interface 150 can be used to generate commands or control operations that allocate or otherwise configure working resources (“working resource set 161”) of the enterprise commands can include, for example, (i) assigning lead or lead profiles to personnel based on, for example, the respective overall value score 151; and/or (ii) creating resources (e.g., new CRM accounts) for new personnel, based on performance projections 145 of lead profiles and/or their respective geographic domains.

As one illustrative example, a lead profile 125 can be evaluated by the resource management system 100 to have a relatively low score, as compared to other lead profiles which the enterprise user can target. The user interactive interface 155 can be used to rank lead profiles 125 by a variety of factors, including the overall value score 151 for each lead profile 125. An enterprise user (e.g., revenue officer) can interact with the interactive interface to, for example, rank lead profiles by overall value score 151. The user can interact with the interface feature 155 to (i) terminate or reduce the level of engagement of the enterprise resources with lower ranked lead profiles 125, and/or (ii) assign or reassign resources (e.g., personnel) to higher ranked lead profiles 125. In variations, ranking, reassigning, increasing/decreasing or terminating engagement efforts with lead profiles can be done automatically through commands, which can be distributed to, for example, the customer CRM 22.

Further, the user interface 150 can include processes for generating alerts or notifications, reflecting changes or updates to lead profiles 125. For example, the alerts can be generated in response to predetermined changes (e.g., 10% change to an overall value score 151 of a lead profile, overall value score 151 above or below a predetermined threshold, etc.).

Still further, real-world event monitoring and/or industry or company-specific trend analysis can be factored into determining the overall value score 151. For example, if an entity associated with a lead profile announces layoff, poor earnings, or a pending acquisition, that could impact the score (e.g., negatively) as those types of events may be associated with a lesser propensity for conversion. The degree to which an event or trend impacts the overall value score can be varied, and learned over time to fine-tune the models and processes used to calculate overall value score 151.

### Methodology

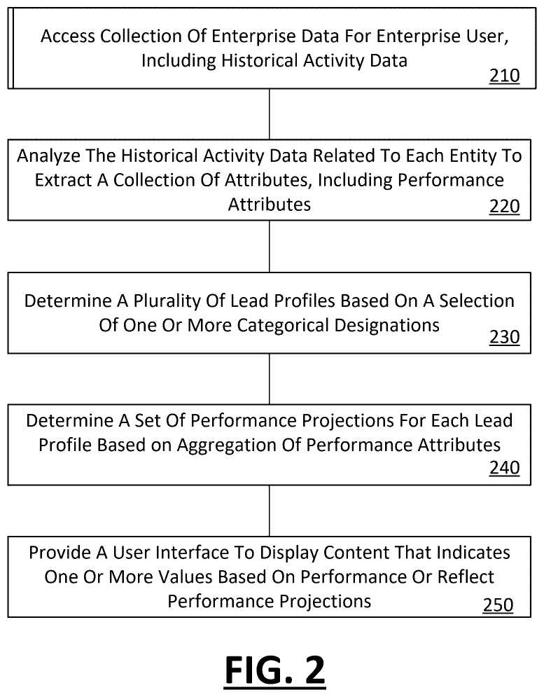

FIG. 2 illustrates an example method for managing resources of an enterprise based on an overall value of a lead profile, according to one or more embodiments. As described with other examples, the lead profile can represent a segment of industry, including entities that represent potential targets of an enterprise's engagement efforts. In describing an example method of FIG. 2, reference may be made to elements of FIG. 1 for purpose of illustrating suitable components or functionality for performing a step or sub-step being described.

With reference to an example of FIG. 2, in step 210, a collection of enterprise data are accessed for an enterprise user, where the collection of data includes historical activity data relating to multiple entities that represent commercial opportunities for the enterprise user. For example, resource management system 100 can include processes that read customer engagement data from a third-party CRM account for an enterprise user, where the customer engagement data includes information about prior engagement activities of the enterprise user with respect to targeted entities. As described with examples, the engagement activities can include those which are successful (e.g., the customer converted or made a purchase), unsuccessful or still in progress. Successful engagement activities can reflect a transaction value, as well as timing information reflecting an engagement duration cycle. In some examples, the resource management system 100 can calculate a transaction duration cycle, reflecting an interval between when engagement activities with a particular target initiated and when it was closed. In variations, the transaction duration cycle can reflect a time interval when negotiations are serious discussions to place, or alternatively when a purchase order or contract was sent over to an entity for review, followed by an approved purchase order or issued payment. Thus, the transaction duration cycle can be predefined, based on, for example a preference of the user and alternative milestones in the engagement of the enterprise with the targeted entity.

The historical activity data for the customer can be structured and normalized by processes of the resource management system 100. Information about individual leads can be structured into engagement records. In some examples processes of the resource management system 100 can evaluate individual engagement records 121 for sufficiency, quality and recency, and any deficiencies can be subject to programmatic processes that seek to populate additional information for engagement record. For some kind of information items, information about an entity can be extrapolated or predicted. For example, parameters representing an incumbent technology, an estimated gross revenue, a projected gross revenue, and other information can be extrapolated, from competitors entities who have the same or similar characteristics.

In step 220, the resource management system 100 analyzes the historical activity data related to each entity to extract a collection of attributes, where the collection of attributes represent values for a plurality of categorical designations of the opportunity field for the enterprise user. In examples, the collection of attributes include performance attributes that are based at least in part on the historical activity data.

In step 230, a plurality of lead profiles are determined, each lead profile associating a categorical designation of the commercial opportunities with an aggregation of attributes for multiple categorical designations of the plurality of categorical designations. The determination can be made in response to selection of one or more categorical designations by, for example, a user interacting with a user interface 150.

In step 240, a set of performance projections are determined for each lead profile, based at least in part on the aggregation of performance attributes. Each performance projection includes parametric information that is based at least in part on the historical activity data for the customer. Projection parameters can further utilize historical data, in combination with stochastic or predictive models, or AI processes, to determine respective values. As described with examples, performance projections can include a win rate associated with the lead profile, a projected transaction size for a conversion event (if one is to take place), and/or a projected conversion duration cycle (e.g., number of days) provide for the enterprise user to close a conversion event with a targeted entity of the same lead profile.

In step 250, a user-interface is provided to display content that is based on, or indicative of the performance projections. In some examples, the content includes an overall value score 151 for an entity. As an addition or variation, the user interface can include controls 159 to enable real-time input and simulation of performance projections and overall value score, based on objectives of the user.

### Example Interfaces

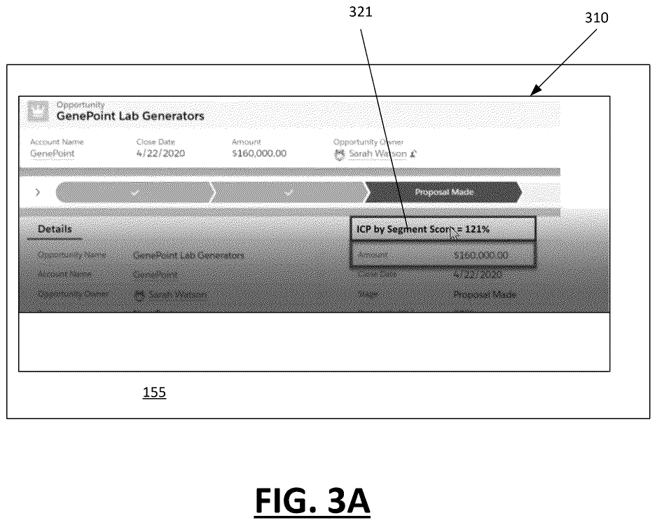

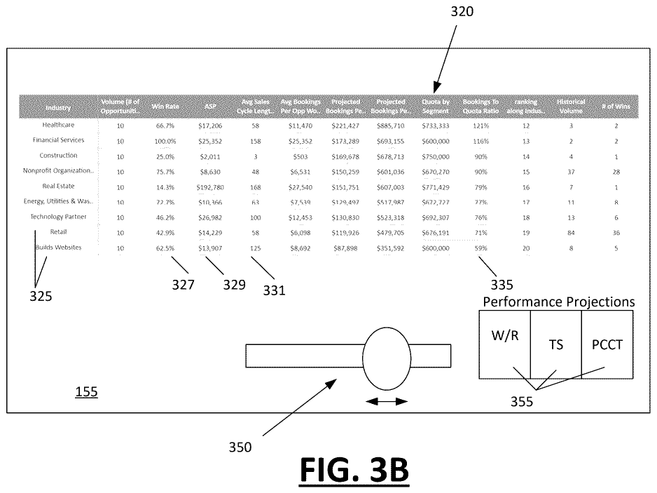

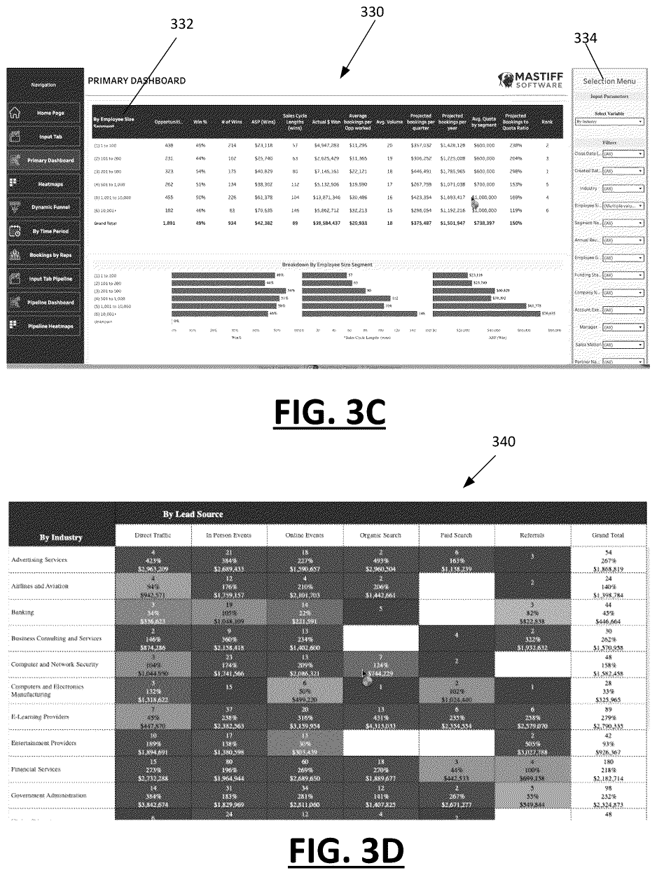

FIG. 3A through FIG. 3D illustrate example interactive interfaces for use with one or more examples, according to one or more embodiments. Example interactive interfaces, as shown and described by FIG. 3A and FIG. 3B, can be implement by resource management system 100, as described with an example of FIG. 1. Accordingly, reference may be made to elements of FIG. 1 for purpose of illustrating context, and functionality for implementing features as described.

With reference to FIG. 3A, the interactive interface 155 can include an interactive engagement record 310 (e.g., corresponding to a rendering of an engagement record) 121 that tracks the effort being made the enterprise user to have targeted entity perform a conversion action (e.g., purchase software licenses). As described examples, an entity (e.g., GENEPOINT LAB GENERATORS) of the engagement record 121 can be associated with a lead profile 125 (in the example shown, a specific entity), based on characteristics of the engagement record. An engagement record 121 can display, for example, information about an associated lead profile, such as an overall value score 321. The rendering of the engagement record 310 can include an overall value score 321 for the lead profile, reflecting a projected value or outcome for the lead relative of a goal (e.g., quota for personnel).

In additional examples, FIG. 3A can also represent an enhanced record of the enterprise user, viewable by personnel in real-time. For example, the system 100 can synchronize the enterprise record (as stored with the CRM) with the engagement records 121, such that each reflects a same view, reflecting the overall value score 151 associated with a particular entity.

With reference to FIG. 3B, the interactive interface 155 can be implemented to provide a lead matrix 320. The lead matrix 320 includes a plurality of lead profiles 325, each lead profile 125 being associated with the industry subcategory and/or subcategory or segment (e.g., enterprise size). Each lead profile 325 can include performance projections 145, such as represented by win rate 327, project transaction size 329, projected average cycle time 331 and/or overall value score 335.

Further, each of the interactive interfaces 155 shown with FIG. 3A and FIG. 3B can include a continuous input mechanism 350 (see FIG. 3B), as described with other examples. As shown with an example, continuous input mechanism 350 can, for example, enable user to specify a desired or target overall value score 151 (via manipulation of the input mechanism 350 along an input continuum), based on a particular quota, and in response, the resource management system 100 returns dynamic data field values 355 that reflect performance projections for enabling achievement of the overall value score. In other variations, the continuous input mechanism 350 can be configured to provide performance projections and/or overall value score when performance projections are changed. As an addition or variation, the input mechanism 350 can be configured to enable the user to vary one or more of the performance projections (e.g., win rate), to for example, simulate other performance projections and/or the overall value score 151 in response to a forced adjustment to one or more select performance projections. By way of example, the user can manipulate the win-rate (e.g., using a bar input, dial input or incremental clicker) to see the new effect on overall performance score 151. Still further, as described with other examples, the continuous input mechanism 350 can be used to enable the user to specify the confidence score, to weigh high-reward high-risk scenarios versus low-reward, low-risk. In such implementation, when the input mechanism is manipulated (e.g., slid left or right), the recommendations (e.g., highest ranked profile leads) can change accordingly.

FIG. 3C illustrates a dashboard view 330 of a customer repository, representing an interface that enables the user to select parameters for lead profiles, according to one or more examples. In the example shown, the lead profile (represented by column 332) is keyed by an employee size category. Alternative lead profiles can be generated based on a selection menu 334 (by industry, by segment, funding date, etc.). Based on projection parameters, lead profiles can also be dynamically determined based on target closing date for an engagement effort. With determination of the lead profile, a set of attributes for the lead profile is determined and listed for the user.

FIG. 3D illustrates the dashboard view with a heatmap, reflecting rankings of profile leads, according to one or more examples. The heatmap view 340 can generate color-coded or visually distinct cells, reflecting relative ranking (best/worst) in terms of value and expenditure of effort and resources. As described with examples, the system 100 can utilize AI component 138 to determine the heatmap for numerous lead profiles, dynamically determined by attributes. As an addition or alternative, the ranking and visual identifiers can reflect an absolute ranking relative to thresholds, quotas, or user-specified objectives.

### Hardware Diagram

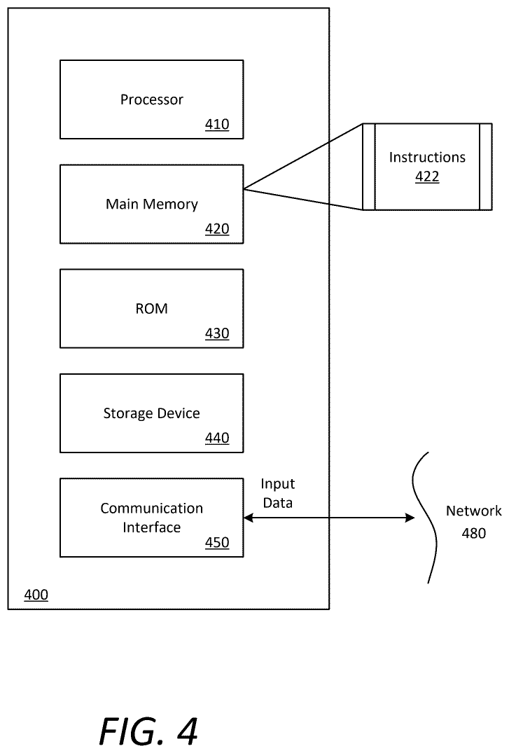

FIG. 4 is a block diagram that illustrates a computer system upon which embodiments described herein may be implemented. For example, in the context of FIG. 1, the system 100 may be implemented using a computer system such as described by FIG. 4. Additionally, a method such as described with an example of FIG. 2 can be implemented using a computer system such as described with an example of FIG. 4. Still further, examples of FIG. 1, FIG. 2 and/or FIG. 3 can be implemented using a combination of multiple computer systems as described by FIG. 4.

In one implementation, a computer system 400 includes processor(s) 410, a main memory 420, a read only memory (ROM) 430, a storage device 440, and a communication interface 450. The computer system 400 includes the at least one processor 410 for processing information and executing instructions stored in the main memory 420. The main memory 420 can correspond to, for example, a random access memory (RAM) or other dynamic storage device, for storing information and instructions to be executed by the processor 410. The main memory 420 can also be used for storing temporary variables or other intermediate information during execution of instructions to be executed by the processor 410. The computer system 400 may also include the ROM 430 and/or other static storage device for storing static information and instructions for the processor 410. A storage device 440, such as a magnetic disk, solid state drive or optical disk, can be provided to store data sets, such as provided by the customer repository 118. The main memory 420 can store instructions 442 for implementing an system or service, such as described with examples of FIG. 1. Additionally, the processor 410 can execute the instructions 442 to implement a method such as described with an example of FIG. 2.

The communication interface 450 can enable the computer system 400 to communicate with one or more networks 480 (e.g., cellular network) through use of the network link (wireless or wireline). Using the network link, the computer system 400 can communicate with, for example, client terminals, servers and one or more third-party network services 10.

Examples described herein are related to the use of the computer system 400 for implementing the techniques described herein. According to one embodiment, those techniques are performed by the computer system 400 in response to the processor 410 executing one or more sequences of one or more instructions contained in the main memory 420. Such instructions may be read into the main memory 420 from another machine-readable medium, such as the storage device 440. Execution of the sequences of instructions contained in the main memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### Conclusion

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computer-implemented method comprising:
accessing a collection of enterprise data for an enterprise user, the collection of enterprise data including a collection of enterprise records, and historical activity data for an enterprise user, the historical activity data relating to multiple entities representing commercial opportunities for the enterprise user;
analyzing the historical activity data related to each entity to extract a collection of attributes, the collection of attributes representing values for a plurality of categorical designations of an opportunity field for the enterprise user;
wherein the collection of attributes include performance attributes that are based at least in part on the historical activity data;
in response to selection of one or more categorical designations, determining a plurality of lead profiles, each lead profile associating a categorical designation of the commercial opportunities with an aggregation of attributes for multiple categorical designations of the plurality of categorical designations;
determining a set of performance projections for each lead profile, based at least in part on the aggregation of performance attributes; and
providing a user-interface to display dynamic content that indicates one or more values that are based on, or reflect, one or more of the performance projections of the set.

2. The computer-implemented method of claim 1, further comprising:
determining a sufficiency of the historical activity data; and
performing a set of operations to enhance or augment the historical activity data.

3. The computer-implemented method of claim 1, wherein providing the user-interface includes providing one or more user-interface features to modify one or more parameters of the set of resource parameters.

4. The computer-implemented method of claim 1, wherein the one or more user-interface features include one or more controls to enable a user to provide a continuous input, to simulate alternative outcomes.

5. The computer-implemented method of claim 1, wherein the set of performance projections include a projected win rate, a projected transaction size, and/or a projected conversion duration cycle.

6. The computer-implemented method of claim 5, further comprising determining an overall value score for each lead profile, where the overall lead value score is based on a ratio of (i) a product of the win rate and projected transaction size, and (ii) a projected duration cycle.

7. A non-transitory computer-readable medium, or software product, comprising instructions, which when executed by one or more processors of a computer system, cause the computer system to perform operations that include:
accessing a collection of enterprise data for an enterprise user, the collection of enterprise data including a collection of enterprise records, and historical activity data for an enterprise user, the historical activity data relating to multiple entities representing commercial opportunities for the enterprise user;
analyzing the historical activity data related to each entity to extract a collection of attributes, the collection of attributes representing values for a plurality of categorical designations of an opportunity field for the enterprise user;
wherein the collection of attributes include performance attributes that are based at least in part on the historical activity data;
in response to selection of one or more categorical designations, determining a plurality of lead profiles, each lead profile associating a categorical designation of the commercial opportunities with an aggregation of attributes for multiple categorical designations of the plurality of categorical designations;
determining a set of performance projections for each lead profile, based at least in part on the aggregation of performance attributes; and
providing a user-interface to display dynamic content that indicates one or more values that are based on, or reflect, one or more of the performance projections of the set.

8. The non-transitory computer-readable medium of claim 7, wherein the operations further comprise:
determining a sufficiency of the historical activity data; and
performing a set of operations to enhance or augment the historical activity data.

9. The non-transitory computer-readable medium of claim 7, wherein providing the user-interface includes providing one or more user-interface features to modify one or more parameters of the set of resource parameters.

10. The non-transitory computer-readable medium of claim 7, wherein the one or more user-interface features include one or more controls to enable a user to provide a continuous input, to simulate alternative outcomes.

11. The non-transitory computer-readable medium of claim 7, wherein the set of performance projections include a projected win rate, a projected transaction size, and/or a projected conversion duration cycle.

12. The non-transitory computer-readable medium of claim 11, wherein the operations further comprise determining an overall value score for each lead profile, where the overall lead value score is based on a ratio of (i) a product of the win rate and projected transaction size, and (ii) a projected duration cycle.

13. A network computer system comprising:
one or more processors;
a memory to store instructions;
wherein the one or more processors execute the instructions to perform operations that include:
accessing a collection of enterprise data for an enterprise user, the collection of enterprise data including a collection of enterprise records, and historical activity data for an enterprise user, the historical activity data relating to multiple entities representing commercial opportunities for the enterprise user;
analyzing the historical activity data related to each entity to extract a collection of attributes, the collection of attributes representing values for a plurality of categorical designations of an opportunity field for the enterprise user;
wherein the collection of attributes include performance attributes that are based at least in part on the historical activity data;
in response to selection of one or more categorical designations, determining a plurality of lead profiles, each lead profile associating a categorical designation of the commercial opportunities with an aggregation of attributes for multiple categorical designations of the plurality of categorical designations;
determining a set of performance projections for each lead profile, based at least in part on the aggregation of performance attributes; and
providing a user-interface to display dynamic content that indicates one or more values that are based on, or reflect, one or more of the performance projections of the set.

14. The network computer system of claim 13, wherein the operations further comprise:
determining a sufficiency of the historical activity data; and
performing a set of operations to enhance or augment the historical activity data.

15. The network computer system of claim 13, wherein providing the user-interface includes providing one or more user-interface features to modify one or more parameters of the set of resource parameters.

16. The network computer system of claim 13, wherein the one or more user-interface features include one or more controls to enable a user to provide a continuous input, to simulate alternative outcomes.

17. The network computer system of claim 13, wherein the set of performance projections include a projected win rate, a projected transaction size, and/or a projected conversion duration cycle.

18. The network computer system of claim 17, further comprising determining an overall value score for each lead profile, where the overall lead value score is based on a ratio of (i) a product of the win rate and projected transaction size, and (ii) a projected duration cycle.
